(19) United States
(12) Patent Application Publication
(10) Pub. No.: US 2024/0158195 A1
(43) Pub. Date: May 16, 2024

(54) CONVEYOR ADAPTED FOR BATTERY MANUFACTURING PROCESS

(71) Applicants: TOYOTA JIDOSHA KABUSHIKI KAISHA, Toyota-shi (JP); PRIMEARTH EV ENERGY CO., LTD., Kosai-shi (JP); PRIME PLANET ENERGY & SOLUTIONS, INC., Tokyo (JP)

(72) Inventors: Taichi URAKAMI, Nisshin-shi (JP); Seiji ISHIZU, Toyota-shi (JP); Masakazu UMEHARA, Toyota-shi (JP); Naohiro ISHIZUKA, Sendai-shi (JP); Naoya KISHIMOTO, Nagoya-shi (JP)

(73) Assignees: TOYOTA JIDOSHA KABUSHIKI KAISHA, Toyota-shi (JP); PRIMEARTH EV ENERGY CO., LTD., Kosai-shi (JP); PRIME PLANET ENERGY & SOLUTIONS, INC., Tokyo (JP)

(21) Appl. No.: 18/380,463

(22) Filed: Oct. 16, 2023

(30) Foreign Application Priority Data
Nov. 15, 2022 (JP) 2022-182726

(51) Int. Cl. B65H 20/02; H01M 4/04; H01M 10/04

(52) U.S. Cl. CPC B65H 20/02; H01M 4/0404; H01M 10/0404; B65H 2403/73; B65H 2404/10

(57) ABSTRACT

In a manufacturing process of a battery or a circuit board, or a printing process, there is a case where a long sheet material is conveyed from an unwinding unit to a winding unit. One object of the present disclosure is to provide a technique capable of preventing the long sheet material from being rubbed by a roller when the material is conveyed. The present disclosure relates to a conveyor adapted for a battery manufacturing process. The conveyor comprises a roller configured to convey a long sheet material, a shaft through the roller; a bearing installed between the roller and the shaft, and a driver configured to rotate the shaft in the same direction as a rotating direction of the roller conveying the long sheet material.

### CROSS-REFERENCE TO RELATED APPLICATION

The present application claims priority under 35 U.S.C. § 119 to Japanese Patent Application No. 2022-182726, filed Nov. 15, 2022, the contents of which application are incorporated herein by reference in their entirety.

### BACKGROUND

### Field

The present disclosure relates to a conveyor for conveying a long sheet material in a battery manufacturing process.

### Background Art

In a lithium secondary battery manufacturing process, a step of supplying coating liquid such as electrode liquid to one surface of a base material such as aluminum foil and then drying the coating liquid while conveying the base material is known. JP 2017-172917A discloses a material processing apparatus which is used in such a step and processes the base material whose main surface is coated by the coating liquid. The material processing apparatus disclosed in JP 2017-172917A is made to prevent the base material from shrinking and being wrinkled due to temperature difference after passing through a drying unit.

### SUMMARY

As disclosed in JP 2017-172917A, in a manufacturing process of a battery or a circuit board, a printing process, or the like, a long sheet material is conveyed from an unwinding unit to a winding unit in some steps. In such steps, the material is guided by rotating rollers so that the material moves along a fixed conveyance path. However, in the manufacturing process of the battery, there is a case where an arrangement of the rollers is limited and a winding angle of the material becomes insufficient and it causes that a rotation speed of the roller does not coincide with a conveyance speed of the material. When the rotation speed of the roller does not coincide with the conveyance speed of the material and the material is rubbed by the roller, it can cause damage or a stain on a surface of the material, and it is not desirable.

The present disclosure is made in view of such a problem. The present disclosure provides a technique capable of preventing a material from being rubbed by a roller when the material is conveyed in a battery manufacturing process.

The present disclosure relates to a conveyor adapted for a battery manufacturing process. The conveyor comprises a roller configured to convey a long sheet material, a shaft through the roller, a bearing installed between the roller and the shaft, and a driver configured to rotate the shaft in the same direction as a rotating direction of the roller conveying the long sheet material.

According to the technique of the present disclosure, it is possible to prevent a material from being rubbed by a roller when the material is conveyed in a battery manufacturing process.

### BRIEF DESCRIPTION OF THE DRAWINGS

FIG. 1A is a diagram illustrating a configuration example of a conveyor according to a present embodiment.

FIG. 1B is a diagram illustrating the configuration example of the conveyor according to the present embodiment in another direction view.

FIG. 1C is a diagram illustrating the configuration example of the conveyor according to the present embodiment in another direction view.

FIG. 2 is a diagram illustrating a configuration example of the conveyor according to the present embodiment.

FIG. 3 is a diagram illustrating a configuration example of a roller in a comparative technique.

FIG. 4A is a diagram for explaining a winding angle.

FIG. 4B is a diagram for explaining a winding angle.

FIG. 5 is a schematic diagram of a coating step included in a battery manufacturing process.

FIG. 6A is a diagram for explaining a scene in which a material is conveyed in a drying furnace in the battery manufacturing process.

FIG. 6B is a diagram for explaining a scene in which a material is conveyed in a drying furnace in the battery manufacturing process.

### DETAILED DESCRIPTION

Embodiments of the present disclosure will be described with reference to the accompanying drawings.

In a printing process, a sourcing process of a circuit board or a lithium-ion battery, or the like, there is a process in which a long sheet material such as film, paper, or metal foil is conveyed. Such a long sheet material is called a web, and a technique for conveying the web is called web handling. In the web handling, the material is continuously fed from an unwinding unit, processed and painted, printed, or coated, and then wound by a winding unit. In such a process, a method of guiding the conveyed material using a roller so that the material is conveyed along a fixed conveyance path between the unwinding unit and the winding unit is generally known.

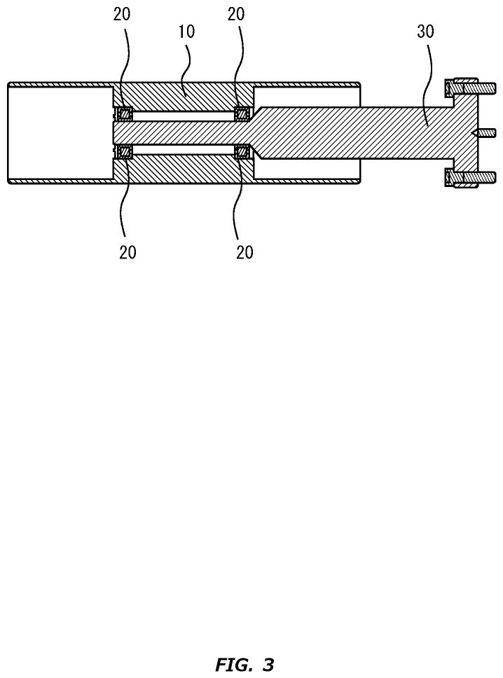

FIG. 3 illustrates an example of a general roller 10 arranged in the conveyance path. The roller 10 is in contact with the material and supports the material. A shaft 30 is fixed, and the roller 10 is supported by a bearing 20 so that the roller 10 can rotate on the shaft 30. While the material is moving, driving force is applied to the roller 10 by static friction force generated between the roller 10 and the material, so the roller 10 rotates in accordance with the movement of the material and can guide the conveyance of the material.

However, according to the configuration as illustrated in FIG. 3, there is a case that the driving force required to rotate the roller 10 becomes insufficient. when the static friction force between the roller 10 and the material becomes small. If the driving force becomes insufficient and smaller than the driving force required to rotate the roller 10, the roller 10 stops rotating. There is a possibility that the material is scratched and damaged by a surface of the roller 10, resulting in a defective product, if the roller 10 stops rotating in accordance with conveyance speed of the material.

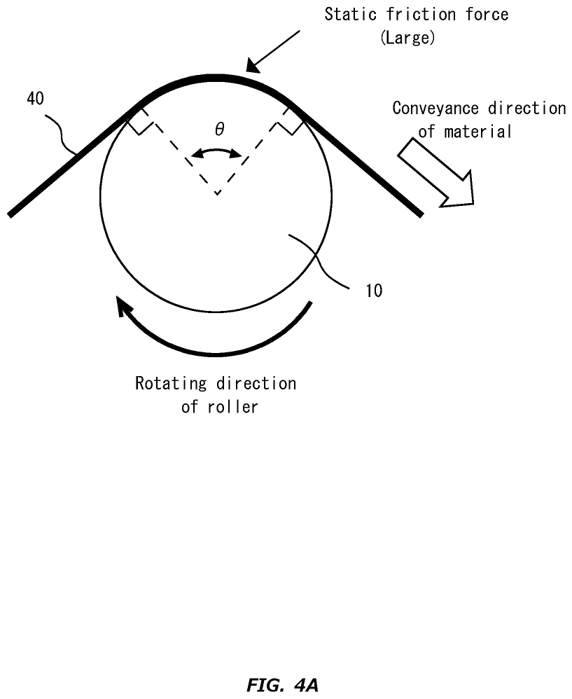

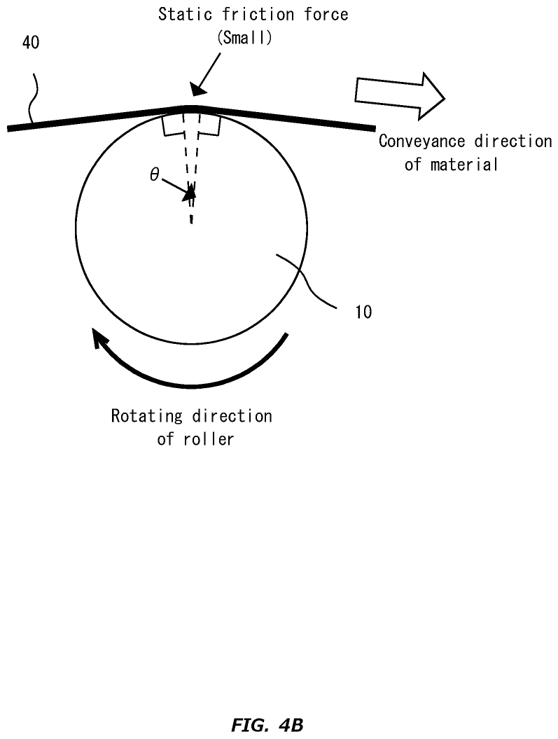

One factor that changes the static friction force is a winding angle of the material around the roller 10. The static friction force decreases as the winding angle decreases. FIGS. 4A and 4B are diagrams illustrating cross sections of the roller 10 in the axial direction view for comparing large and small winding angles. FIG. 4A illustrates a case where the winding angle of the material 40 is large, and FIG. 4B illustrates a case where the winding angle of the material 40 is small. The winding angle is a central angle of an arc formed by a cross section of a portion where the material 40 is in contact with the roller 10. The winding angle is also referred to as a wrap angle. In FIGS. 4A and 4B, the winding angles are represented by θ.

When the winding angle is large as shown in FIG. 4A, there is not a problem because a sufficiently large static friction force occurs between the roller 10 and the material 40. However, when the winding angle of the material 40 is small as shown in FIG. 4B, the static friction force between the roller 10 and the material 40 becomes small because a contact length between the roller 10 and the material 40 is short. There is a possibility that the roller 10 does not rotate even though the material 40 is moving if torque applied to the roller 10 by the static friction force is less than torque required to start rotating the roller 10. As a result, the material 40 rubs against the surface of the roller 10, and there is a possibility that the material 40 contaminates or damages the roller 10 or the surface of the material 40 is damaged by the roller 10, resulting in a defective product.

If all the rollers 10 installed on the conveyance path are arranged so that the winding angles of the material 40 become large enough, the above-described problem does not occur. However, in a battery manufacturing process, there is a case where it is difficult to keep the winding angle of the material 40 large.

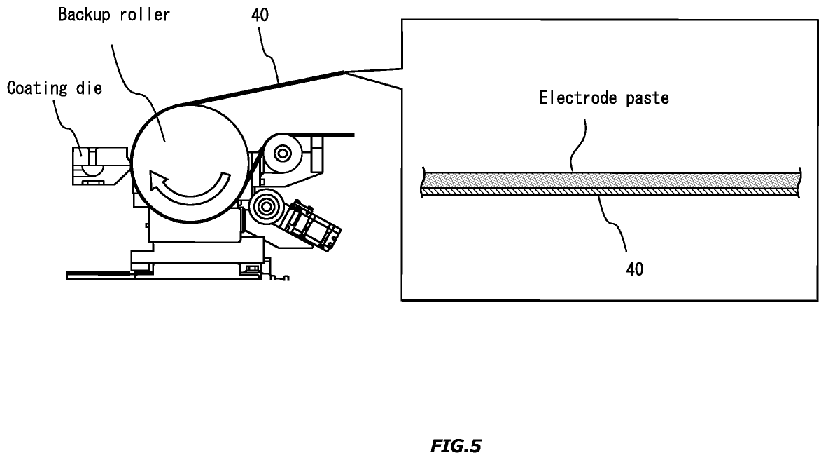

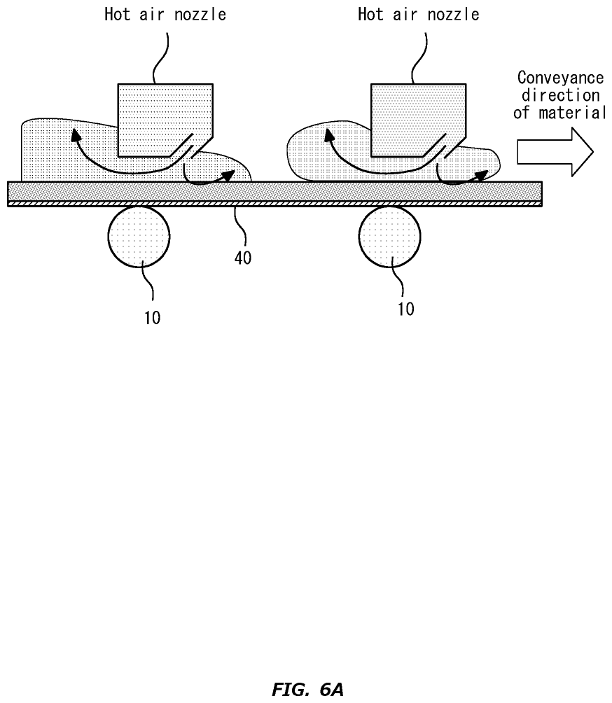

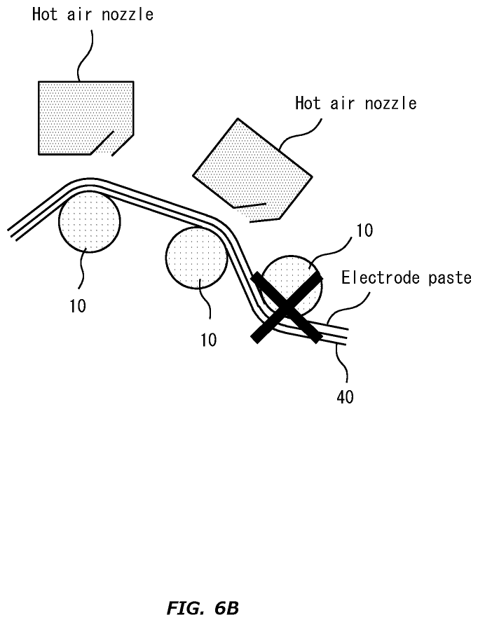

An example of a situation where it is difficult to increase the winding angle is described with reference to FIGS. 5, 6A, and 6B. FIG. 5 illustrates an outline of a coating step which is included in the sourcing process of the lithium-ion battery and in which the material 40 is coated with liquid. The material 40 is metal foil used as a material of a battery electrode and is coated with liquid electrode paste when passing through the coating die. As illustrated in an enlarged view of FIG. 5, one surface of the material 40 after the coating step is wet with the electrode paste. In order to dry the electrode paste, the material 40 is conveyed to a drying furnace after the coating step.

As shown in FIG. 6A, in the drying furnace, the material 40 moves by being supported by the roller 10 and the electrode paste is gradually dried by hot air blown from a hot air nozzle. At this time, since several tens of the hot air nozzles are required to sufficiently dry the electrode paste, distance which the material 40 moves in the drying furnace becomes longer by that amount. Therefore, if the rollers 10 are arranged so as to increase the winding angle, some of the rollers 10 must be arranged so that the material 40 is wound with its surface coated with the electrode paste facing inward, as shown in FIG. 6B. However, since the surface of the material 40 coated with the electrode paste is wet until drying is finished, the material 40 cannot be wound with its surface coated with the electrode paste facing inward. As described above, in the battery manufacturing process, there is a step where the winding angle of the material 40 around the roller 10 has to be made small.

A conveyor of the present embodiment, which is described below, is devised so as to be able to prevent the material from rubbed by the roller even when the winding angle of the material around the roller cannot be increased as described above.

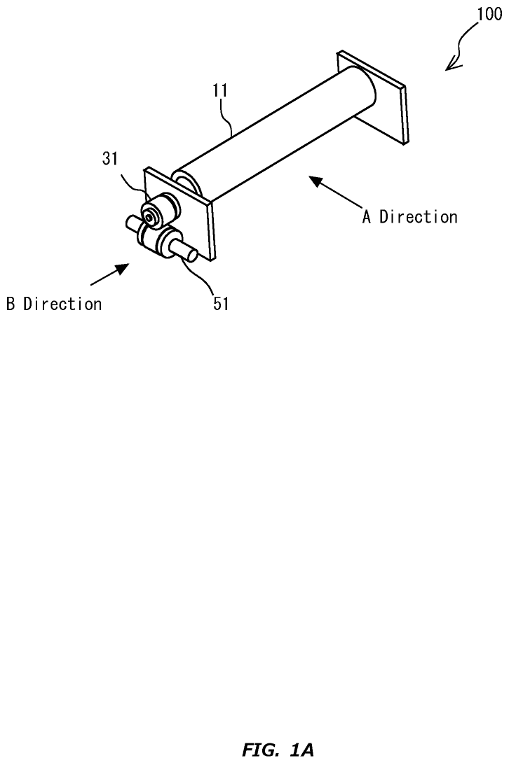

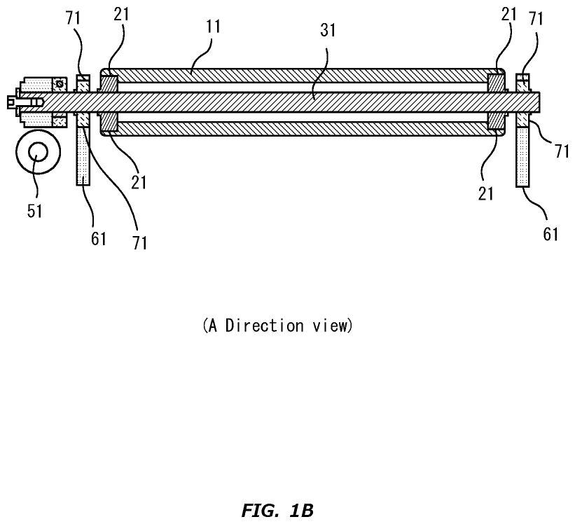

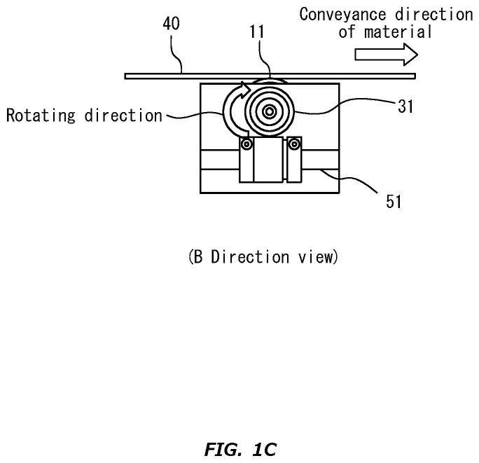

FIGS. 1A, 1B, and 1C illustrate a configuration example of a conveyor 100 according to the present embodiment. FIGS. 1B and 1C illustrate the conveyor 100 of FIG. 1A in the side view and in the axial direction view, respectively. Only FIG. 1C illustrates the conveyor 100 in a scene where the material 40 is conveyed.

The conveyor 100 comprises a roller 11, a bearing 21, a roller through shaft 31, and a driver 51. Also in the conveyor 100, the material 40 is conveyed while being in contact with and supported by the roller 11. The conveyor 100 further comprises a roller through shaft 31, which can rotate on the same axis as the roller 11. In the configuration of FIGS. 1A, 1B, and 1C, the roller through shaft 31 is rotatable since it is supported by a base 61 via a bearing 71. The roller through shaft 31 is through the roller 11, and the roller 11 is rotatably supported by the bearing 21 with respect to the roller through shaft 31.

The roller through shaft 31 can be rotated by driving force provided from the driver 51. While the material 40 is conveyed, the conveyor 100 provides the roller through shaft 31 with the driving force from the driver 51 and rotates the roller through shaft 31. The rotating direction at this time is the same as the conveyance direction of the material 40 as shown in FIG. 1C. By the roller through shaft 31 rotating, torque for rotating in the same direction as the conveyance direction of the material 40 is provided for the roller 11 via the bearing 21. Since the rotation of the roller 11 is assisted by the roller through shaft 31 like this, the roller 11 can rotate in accordance with the conveyance of the material even if the static friction force occurring between the roller 11 and the material 40 is small.

It is preferable that the driver 51 rotates the roller through shaft 31 at a rotation speed such that circumferential speed of the roller 11 is equal to the conveyance speed of the material 40 when it is assumed that the roller 11 rotates together with the shaft 31. However, the rotation speed of the roller through shaft 31 is not limited to a speed equal to the rotation speed of the roller 11 such that the circumferential speed of the roller 11 is equal to the conveyance speed of the material 40 and may be, for example, a speed slightly lower than that. Also in this case, at least the torque required to start the rotation of the roller 11 can be given to the roller 11 by the roller through shaft 31. Therefore, even when the static friction force occurring between the roller 11 and the material 40 is small, the rotation of the roller 11 can be assisted.

In addition, in the present embodiment, the bearing 21 is configured such that torque required from the roller 11 to rotate with respect to the roller through shaft 31 is decreased. Since the roller 11 is not perfectly fixed to the roller through shaft 31 and is supported such that it can be rotated by small torque with respect to the roller through shaft 31, the rotation speed of the roller 11 can be finely corrected. In other words, even when the circumferential speed of the roller 11 and the conveyance speed of the material 40 become slightly different, the rotational speed of the roller 11 is corrected such that the circumferential speed of the roller 11 is equal to the conveyance speed of the material 40 by the torque given by the material 40 to the roller 11 due to the static friction force occurring between the roller 11 and the material 40.

One driver 51 for each of the roller through shafts 31 may be installed, and the driving force may be independently transmitted to each of the roller through shafts 31. Alternatively, one driver 51 for a plurality of roller through shafts 31 may be installed, and the driving force may be transmitted to a plurality of roller through shafts 31 in conjunction from one driver 51.

The driver 51 and the roller through shaft 31 may be physically connected by a gear, a chain, a pulley, or the like to transmit the driving force. However, in the battery manufacturing process, there is a case where the gear or the chain, which is possible to generate a foreign body of metal, cannot be used. Therefore, in the present embodiment, the driver 51 and the roller through shaft 31 are coupled by a magnetic coupling to transmit the driving force.

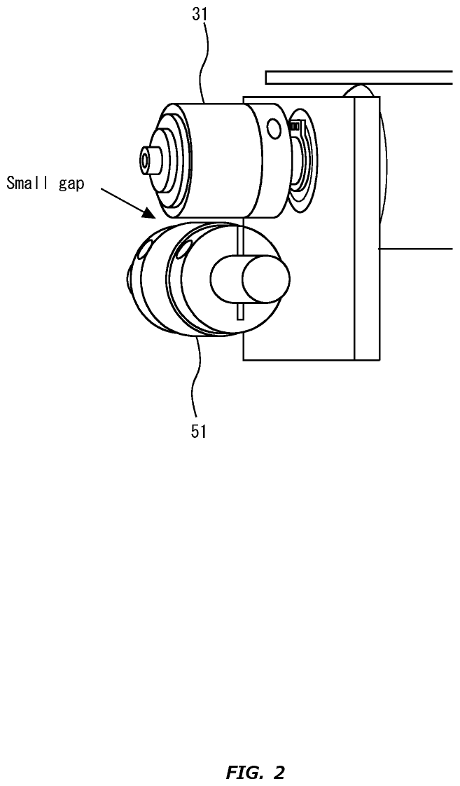

By using the magnetic coupling to transmit the driving force, the driver 51 and the roller through shaft 31 have not necessarily to be in physical contact with each other and it becomes possible to provide a small gap between the driver 51 and the roller through shaft 31 as shown in FIG. 2. For the driver 51 shown in FIG. 2, an orthogonal type magnetic coupling is used in which the roller through shaft 31 and a driving shaft of the driver 51 are orthogonal to each other. By using the magnetic coupling, it is possible to prevent occurrence of a foreign body of metal due to sliding between the driver 51 and the roller through shaft 31.

As described above, according to the conveyor of the present embodiment, rotation of the roller is assisted such that the roller rotates in accordance with conveyance of the material even when the static friction force between the roller and the material is small. As a result, it is possible to prevent occurrence of damage or a stain on the material or the roller due to occurrence of rubbing between the roller and the material.

Although the conveyor is described as used in the battery manufacturing process in the above description, the conveyor of the present embodiment can be applied to various situations where the conveyance path is limited in the web handling process other than the battery manufacturing process. For example, the conveyor of the present embodiment can be applied to a scene in which a material is conveyed a long distance while being dried after the material is finished being printed in a printing process.

What is claimed is:

1. A conveyor adapted for a battery manufacturing process, the conveyor comprising:
a roller configured to convey a long sheet material;
a shaft through the roller;
a bearing installed between the roller and the shaft; and
a driver configured to rotate the shaft in a same direction as a rotating direction of the roller conveying the long sheet material.

2. The conveyor according to claim 1, wherein
the driver is further configured to rotate the shaft such that circumferential speed of the roller is equal to conveyance speed of the long sheet material.

3. The conveyor according to claim 1, wherein
the driver transmits driving force to the shaft via a magnet coupling.
